(19) United States
(12) Patent Application Publication
(10) Pub. No.: US 2025/0069350 A1
(43) Pub. Date: Feb. 27, 2025

(54) SYSTEM AND METHOD FOR REMIXING 3D ASSETS USING GENERATIVE AI

(71) Applicant: Brinx Software Inc., Ottawa (CA)

(72) Inventors: Po Kong Lai, Ottawa (CA); Jonathan Gagne, Ottawa (CA)

(21) Appl. No.: 18/812,572

(22) Filed: Aug. 22, 2024

Related U.S. Application Data
(60) Provisional application No. 63/578,247, filed on Aug. 23, 2023.

(51) Int. Cl. G06T 19/20; G06T 13/20; G06T 15/00; G06T 17/20

(52) U.S. Cl. CPC G06T 19/20; G06T 13/20; G06T 15/005; G06T 17/20

(57) ABSTRACT

A computer-implemented system and method for creating new three dimensional (3D) assets through a remixing process guided by a generative artificial intelligence (AI) system by remixing different media component data streams in a source 3D asset with input user data to provide a new 3D asset. User supplied data is input to the remixing system as guidance and the remixing system has multiple generative AIs which work serially and/or in parallel on remixing different media components of the 3D asset. The generative AI is used in a remixing pipeline to consume one or more media type to produce a new remixed media type, and the remixed media component types are merged into a new 3D asset.

### CROSS-REFERENCE TO RELATED APPLICATIONS

This application claims priority to United States provisional patent application U.S. 63/578,247 filed 23 Aug. 2023, which is hereby incorporated by reference herein in its entirety.

### FIELD OF THE INVENTION

The present invention pertains to a system and method in which three dimensional (3D) assets are created through a remixing process guided by a generative artificial intelligence (AI) system. The present invention also pertains to AI-assisted procedural generation techniques for 3D asset generation.

### BACKGROUND

Current systems of 3D asset creation require a high degree of manual user input, specific tools, and specialized training in order to create a usable 3D asset. In broad strokes, the main phases for creating an animated 3D asset such that it can be deployed to existing 3D engines are, in order, concepting, shape creation, UV mapping, texture painting, skinning and rigging, animation, and optimization. First, in the concepting phase, at least one artist produces a series of two dimensional (2D) images that depict an interpretation of the desired outcome from a creative brief. A writer can also fill in this role by producing written descriptions and oftentimes both image and text outputs are desired. In shape creation a 3D modeler uses the application of their choice to produce an initial 3D shape. This phase involves multiple iterations as the modeler gets feedback in addition to updates on the initial concept. The output is the desired 3D shape, represented as a mesh (a collection of vertices and polygons in 3D space), but has no textures (the 2D images which are used to give the 3D shape color and other appearance based properties). In order to apply 2D texture images to a 3D mesh it needs to be unfolded and flattened to a 2D plane. The flattened version of the mesh is known as the UV map. Producing a high quality UV map is best accomplished via a specialist who marks regions of the mesh which can be flattened, and arranges all the shapes in order to optimize the amount of image space which can be used. With a UV map defined, a 3D artist can manually paint the colors and other appearance based properties onto the mesh using texture painting. Much like shape creation, this process will also take multiple iterations, often with other stakeholders.

In order to animate a 3D asset, a specialist is needed to create the bones, known as the rig, of the model and bind each vertex of the mesh from the previous phase to different bones via a process known as skinning. The whole process of creating the skeleton and coordinating the shape, texture, and surface of the object to the skeleton is called skinning and rigging. Once vertices are skinned to different bones, then moving the bones will in turn move the mesh. Finally, once the asset has passed through these first phases, an animator can move the bones to create animation clips of the mesh performing actions like walking, running and jumping. Similar to shape creation and texture painting, the animation process can also take multiple iterations and involvement with other stakeholders. Once all of this work has been completed, the created asset is now ready to be optimized for specific platforms. This process often involves someone tuning the parameters of algorithms to highly specific requirements like number of polygons in the mesh or the resolution of textures. Sometimes a manual edit is required. If the stakeholders' desired additions to the shape or other more detailed modifications, like adding more limbs, which requires updating the rig and skin, then the entire process will have to be repeated from the earliest phase that needs to be updated.

This entire process from concepting to optimization is complex and requires multiple specialists, accordingly any contribution that could speed up the process or require the intervention of fewer specialists would be of great value for new 3D asset generation.

In one example of 3D rendering and animation, U.S. Pat. No. 11,403,800 to Prokudin et al. describes a method and system for image generation from 3D model using neural network using a neural rasterizer for translating a sparse set of 3D points to realistic images by reconstructing projected surfaces directly in the pixel space without relying on a traditional 3D rendering pipeline.

Procedural generation for 3D assets can be thought of as a traditional approach for producing a variety of assets from a set of heuristics. In essence, procedural generation algorithms produce an output 3D asset, or elements of it, by starting from a set of human defined parameters which are then combined with a set of custom domain specific rules, where the resulting output satisfies both the parameters and rules. For example, one could procedurally construct trees by starting from a set of parameters like the height or height range of a tree, the number of branches or range of distance between branch points, range of number of leaves per branch, and so on. The rules could be how and when branches are made and how the leaves are attached. While these procedural solutions can be quite powerful, they are often highly specialized to specific object types and styles and require expert domain knowledge.

In an example of procedural synthetic data generation, U.S. Pat. No. 10,235,601 to Wrenninge et al. describes a method for synthetic data generation and analysis by determining a set of parameter values, generating a scene based on the parameter values, rendering a synthetic image of the scene, and generating a synthetic dataset including a set of synthetic images. In a procedural generation model, changing the system so that it deviates from its specialization would require building of new parameters and rule sets which in turn becomes building a new procedural generation system. The more general the system, the more parameters to tweak and thus the system becomes more complex to understand and use. Furthermore, remixing assets produced from one procedural system with assets produced from another is not possible without development of new systems.

Recent advances in large language models (LLM) have allowed for the creation of novel generative AI solutions to some of the phases of concepting, shape creation, UV mapping, texture painting, skinning and rigging, animation, and optimization as described above. Unlike procedural generation systems, generative AI does not require a human to specify the parameters and rules for how exactly to produce an output. Instead, these LLMs have been trained on large corpuses of textual data containing communication of concepts, ideas and dialogue between real human beings. As a result, these LLMs are able to bridge a crucial gap between user experience (UX) and creative power as the user can describe what they want rather than tune hundreds or thousands of parameters which require expert domain knowledge to understand. Most notably, the Stable Diffusion application can directly generate images of different styles featuring different objects directly from text which assists with the concepting phase. Other methods like DreamFusion® from Google and Magic3D® from NVIDIA are able to use these LLMs to drive the generation of 3D shapes in the form of volumes, without restriction on the object type, which can assist with the initial shape generation phase. Similarly, it has been shown that animation of a rig can be accomplished via the use of a LLM using a motion-diffusion-model. The main underlying theme of these current LLM-based generative solutions is that they have the potential to offer a large amount of variation over a large set of object types and styles, however each of these platforms only covers one or two specific aspects of the 3D asset pipeline and do not generally allow for the remixing of all aspects of 3D assets.

With the challenges faced with creating a 3D asset traditionally, recent advances in creative generative AI combined with new large databases of 3D assets, such as the objaverse released from the Allen Institute for AI, has resulted in an environment from which a 3D remixing system can become very valuable. Thus, there is a need for a method which leverages the advances in AI and existing 3D assets in order to more easily generate 3D assets.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a system and method for creating three dimensional (3D) assets through a remixing process guided by a generative artificial intelligence (AI) system. The present invention also pertains to AI-assisted procedural generation techniques for 3D asset generation by remixing different media data streams in a source 3D asset with input user data to provide a new 3D asset.

In an aspect there is provided a computer-implemented method comprising: receiving user input data; receiving a source 3D asset comprising one or more media component data subsets, each media component data subset pertaining to a media component of the source 3D asset; directing the one or more media component data subsets to a remixing pipeline selector to direct each of the plurality of media data subsets to a remixing engine specific to the media component data subset; in a remixing engine, remixing each media component data subset in a remixer with the user input data to produce a plurality of remixed media components; and in a merging engine, merging the plurality of remixed media components to provide a new output 3D asset.

In an embodiment, each of the remixers in the remixer engine is a generative AI.

In another embodiment, the source 3D asset comprises a mesh comprised of one or more vertices, polygons, and implicit surfaces.

In another embodiment, the media component is one or more of 3D mesh geometry, 3D point cloud geometry, 3D volumes, audio data, animation data, texture maps, texture type, material properties, asset shape, texture, animation features, structure, bones, rig, UV map, implicit surfaces, volume, skin, luminosity, skin transparency, external effects such as asset-associated graphics, voice, sound effects, sound tonality, and volume.

In another embodiment, the media component data subset comprises one or more of a point cloud, implicit surface, signed distance field, volume, constructive solid geometry, RGB-D image, spatial data structure, occupancy grid, 3D curve, 3D parametric surface, neural network weight that represent 3D data, neural radiance field, and mesh composed of vertices and polygons.

In another embodiment, the input 3D asset is provided by the user, a 3D asset repository, or a generative AI.

In another embodiment, the input 3D asset comprises one or more implicit surfaces, point clouds, volumes, and neural network weights that represent 3D data such as neural radiance fields.

In another embodiment, the method further comprises applying a new media component data subset from a template 3D model that is not one of the one or more media component data subsets in the 3D asset to add a new media component to the new output 3D asset.

In another embodiment, the user input data comprises one or more of text, image, video, 3D asset, audio, recorded motion, and gesture.

In another embodiment, the method further comprises, in the merging engine, applying a weighting to the plurality of remixed media components.

In another embodiment, the user input data is vector embedded user input data.

In another embodiment, the method further comprises vector embedding the user input data to provide vector embedded user input data and using the vector embedded user input data in the remixing engine.

In another embodiment, the method further comprises calculating a similarity score between the user input data and the new output 3D asset.

In another aspect there is provided a system for remixing 3D assets comprising: a memory with instructions stored thereon; and a processing device, coupled to the memory, the processing device configured to access the memory, wherein the instructions when executed by the processing device, cause the processing device to perform operations including: receiving user input data; receiving a source 3D asset comprising one or more media component data subsets, each media component data subset pertaining to a media component of the source 3D asset; directing the one or more media component data subsets to a remixing pipeline selector to direct each of the plurality of media data subsets to a remixing engine specific to the media component data subset; in a remixing engine, remixing each media component data subset in a remixer with the user input data to produce a plurality of remixed media components; and in a merging engine, merging the plurality of remixed media components to provide a new output 3D asset.

In an embodiment, each remixer comprises one or more of a vector embedding function, a data pre-processing function, a generative AI (GenAI) system, a data post-processing function, and a data combination function.

In another embodiment, the source 3D asset is provided by the user, a 3D asset repository, or a generative AI.

In another embodiment, the user input data comprises one or more of text, image, video, 3D asset, audio, recorded motion, and gesture.

In another embodiment, the operations further comprise vector embedding the user input data to provide vector embedded user input data and using the vector embedded user input data in the remixing engine.

In another embodiment, the operations comprise applying a new media component data subset from a template 3D model that is not one of the one or more media component data subsets in the 3D asset to add a new media component to the new output 3D asset.

In another embodiment, the operations comprise, in the merging engine, applying a weighting to the plurality of remixed media components.

In another embodiment, the media component comprises one or more of 3D mesh geometry, 3D point cloud geometry, 3D volume, audio data, animation data, texture maps, texture type, material properties, asset shape, texture, animation features, structure, bones, rig, UV map, implicit surfaces, volume, skin, luminosity, skin transparency, external effects such as asset-associated graphics, voice, sound effects, sound tonality, and volume.

Embodiments of the present invention as recited herein may be combined in any combination or permutation.

### BRIEF DESCRIPTION OF THE FIGURES

For a better understanding of the present invention, as well as other aspects and further features thereof, reference is made to the following description which is to be used in conjunction with the accompanying figures which illustrate embodiments or aspects of the invention, where:

FIG. 1 is a flowchart depicting an example implementation of the method;

FIG. 2 illustrates different media components which can make up a 3D asset;

FIG. 3 illustrates different user input data that can be used as input to the present system and method;

FIG. 4 is a flowchart depicting one example implementation of a method for remixing a 3D asset;

FIG. 5A is a flowchart depicting a general example of a vector embedding using a media component as input;

FIG. 5B is a flowchart depicting an example vector embedding block using an input image;

FIG. 6A is a flowchart depicting a vector embedding block using text as input;

FIG. 6B is a flowchart depicting a vector embedding block using an input image;

FIG. 7 is a flowchart depicting an example vector embedding generation from a 3D shape using virtual cameras;

FIG. 8 is a flowchart depicting an example of mixing two different media types into a single vector embedding;

FIG. 9 is a flowchart depicting an example of a remixing pipeline or remixer;

FIG. 10 is a flowchart depicting an example of creation of a template 3D model using a generative AI remixer to create a new 3D asset;

FIG. 11 is a flowchart depicting an example of the identification of a mesh using user input data;

FIG. 12 is a flowchart depicting an example of a remixing pipeline that takes user input data and a template mesh to generate a new 3D mesh;

FIG. 13 is a flowchart depicting another example of a remixing pipeline that takes user input data and a template mesh to generate a new 3D mesh;

FIG. 14 is a flowchart of an example remixing pipeline that takes user input data and a template mesh to generate a new 3D mesh;

FIG. 15 is a flowchart depicting an example of a remixing pipeline that takes user input data and a template model to generate a new textured 3D model;

FIG. 16 is a flowchart depicting another example of a remixing pipeline that takes user input data and a template model to generate a new textured 3D model;

FIG. 17 is a flowchart depicting another example of a remixing pipeline that takes user input data and a template model to generate a new textured 3D model;

FIG. 18 is a flowchart depicting an example of a remixing pipeline that take user input data and a template model to generate a new animated 3D model;

FIG. 19 is a flowchart depicting another example of a remixing pipeline that takes user input data and a template model to generate a new animated 3D model;

FIG. 20 is a flowchart with graphical illustration of generation of a new 3D asset from a source 3D asset having geometry;

FIG. 21 is a flowchart with graphical illustration of generation of a new 3D asset from a source 3D asset having geometry and texture;

FIG. 22 is a flowchart with graphical illustration of generation of three new 3D asset from a source 3D asset with texture remixing;

FIG. 23 is an illustration of a plurality of new 3D assets generated from a source 3D asset with different input data;

FIG. 24 is a flowchart of an embodiment of a shape remixer using a shape vector database; and

FIG. 25 is an illustration of non-humanoid outputs generated by the present 3D asset remixing system.

### DETAILED DESCRIPTION OF THE INVENTION

Unless defined otherwise, all technical and scientific terms used herein have the same meaning as commonly understood by one of ordinary skill in the art to which this invention belongs. Working examples provided herein are considered to be non-limiting and merely for purposes of illustration.

As used in the specification and claims, the singular forms “a”, “an” and “the” include plural references unless the context clearly dictates otherwise.

The term “comprise” and any of its derivatives (e.g. comprises, comprising) as used in this specification is to be taken to be inclusive of features to which it refers, and is not meant to exclude the presence of any additional features unless otherwise stated or implied. The term “comprising” as used herein will also be understood to mean that the list following is non-exhaustive and may or may not include any other additional suitable items, for example one or more further feature(s), component(s) and/or element(s) as appropriate.

As used herein, the terms “having,” “including” and “containing,” and grammatical variations thereof, are inclusive or open-ended and do not exclude additional, unrecited elements and/or method steps, and that that the list following is non-exhaustive and may or may not include any other additional suitable items, for example one or more further feature(s), component(s) and/or element(s) as appropriate. A composition, device, article, system, use, process, or method described herein as comprising certain elements and/or steps may also, in certain embodiments consist essentially of those elements and/or steps, and in other embodiments consist of those elements and/or steps and additional elements and/or steps, whether or not these embodiments are specifically referred to.

As used herein, the term “about” refers to an approximately +/−10% variation from a given value. It is to be understood that such a variation is always included in any given value provided herein, whether or not it is specifically referred to. The recitation of ranges herein is intended to convey both the ranges and individual values falling within the ranges, to the same place value as the numerals used to denote the range, unless otherwise indicated herein.

The use of any examples or exemplary language, e.g. “such as”, “exemplary embodiment”, “illustrative embodiment” and “for example” is intended to illustrate or denote aspects, embodiments, variations, elements or features relating to the invention and not intended to limit the scope of the invention.

As used herein, the terms “connect” and “connected” refer to any direct or indirect physical association between elements or features of the present disclosure. Accordingly, these terms may be understood to denote elements or features that are partly or completely contained within one another, attached, coupled, disposed on, joined together, in communication with, operatively associated with, etc., even if there are other elements or features intervening between the elements or features described as being connected.

As used in this application, the terms “component,” “system,” “platform,” “layer,” “controller,” “terminal,” “station,” “node,” “interface” are intended to refer to a computer-related entity or an entity related to, or that is part of, an operational apparatus with one or more specific functionalities, wherein such entities can be either hardware, a combination of hardware and software, software, or software in execution. For example, a component can be, but is not limited to being, a process running on a processor, a processor, a hard disk drive, multiple storage drives (of optical or magnetic storage medium) including affixed (e.g., screwed or bolted) or removably affixed solid-state storage drives; an object; a file or folder containing data; an executable; a thread of execution; a computer-executable program, and/or a computer. By way of illustration, both an application running on a server and the server can be a component. One or more components can reside within a process and/or thread of execution, and a component can be localized on one computer and/or distributed between two or more computers. Also, components as described herein can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that provides at least in part the functionality of the electronic components. As further yet another example, interface(s) can include input/output (I/O) components as well as associated processor, application, or Application Programming Interface (API) components. While the foregoing examples are directed to aspects of a component, the exemplified aspects or features also apply to a system, platform, interface, layer, controller, terminal, and the like.

Herein is described a system and method for remixing three dimensional (3D) graphical assets using generative artificial intelligence (GenAI). In particular, new 3D assets can be created through a remixing process guided by a generative AI system using procedural generation by remixing different media component data streams in a source 3D asset with input user data. The present system simplifies the complex process of new 3D asset generation so that a single user can produce varied new 3D assets with little technical knowledge. User supplied data in one or more of a variety of media formats can be input to the remixing system as guidance which is mixed with one or more provided or extracted 3D assets using a plurality of generative AI remixers. The present remixing system and method separates media component data streams from this source 3D asset into different media component data subsets and uses multiple remixing pipelines, one for each media component data subset, which work in series and/or in parallel to remix the different media components of the 3D asset. Each remixing pipeline consumes one or more media component data subset associated with the 3D asset along with the user input data to produce a new remixed media component data subset. The output from each remixer, which is a remixed media component data subset, can then be merged with the output of other remixers to create the new 3D asset.

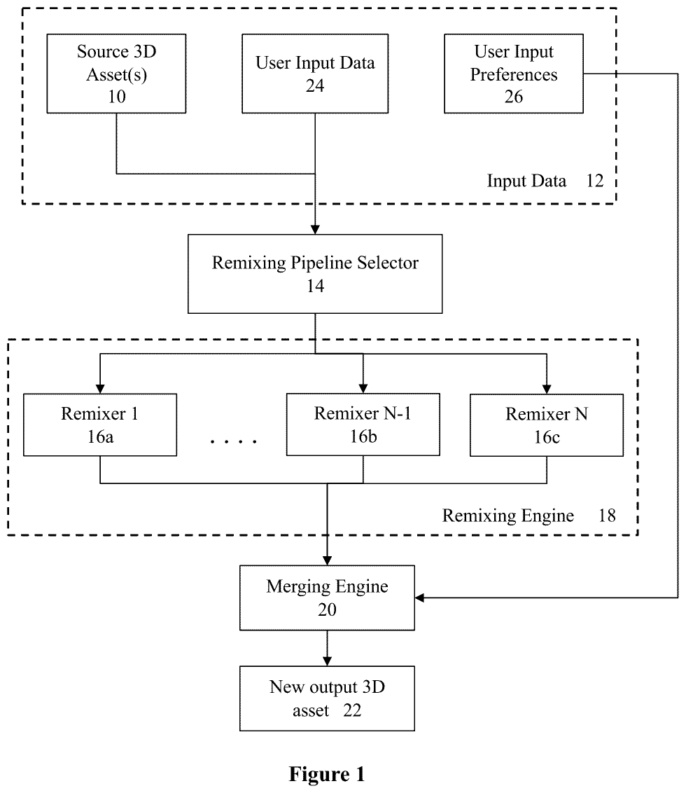

FIG. 1 depicts a flowchart of an example implementation of a method of remixing 3D assets using a generative artificial intelligence (GenAI). In this example, input data 12 in the form of one or more source 3D assets 10, along with user input data 24 from one or more different data modalities, and optional user input preferences 26 which comprise additional parameters, is passed through a remixing pipeline selector 14. User input data 24 refers to specific media or media assets or parts or media components thereof which are provided by the user as input data 12 to the system. Some examples of user input data 24 include but are not limited to a textual description of what the user wants, a reference image or 3D model, and other types of data that can be received by a user interface (UI) to discern the user wishes. User preferences 26 are variables that can be adjusted in a front-end UI that pertain to the data presentation of the desired output for the output 3D asset. Some examples of user preferences 26 include but are not limited to mesh resolution, resolution of the textures, name of the file, format of the file, scale in meters, etc. The user preferences can become aspects of the output 3D asset which are useful and practical for the data format of the output 3D asset but do not need to be input to the remixers 16a, 16b, 16c in the remixing engine 18. Remixing engine 18 comprises a plurality of remixers 16a-c, shown as remixers 1-N, or 1 . . . , N−1, and N. Each remixer 16a-c remixes a single media component data subset of the source 3D asset 10 based on the user input data 24.

Given a mixture of data modalities each pertaining to a different media component in the source 3D asset 10, the input data 12 is subjected to an algorithm in the remixing pipeline selector 14 for selecting the right remixing pipeline algorithm for processing user data into a new output 3D asset 22. In some embodiments, the media components in the source 3D asset 10 can pertain to, for example, 3D mesh geometry, 3D volumes, audio, animation data, texture maps, materials, asset shape, texture, animation features, bones, rig, UV map, volume, skin, luminosity, skin transparency, external effects such as asset-associated graphics, voice, audio or sound effects, sound tonality, and sound volume. In an embodiment, the media component data subset that is directed to an individual remixer is comprised of data specific to a single media component of the source 3D asset 10. The pipeline algorithm in the remixing pipeline selector 14 can be implemented by examining which media components already exist in the source 3D asset 10 and what the user wishes to be added, for example user input data 24 in the form of voice or audio clips can add voice or audio clips to the new output 3D asset 22 even if the source 3D asset 10 did not have any voice clips. Note that the pipeline(s) or remixer(s) selected by the remixing pipeline selector 14 does not have to output the same format as the input media components. Furthermore, the input media components can be converted into vector embeddings which would then allow for the selection of any remixing pipeline. Preferably, each source 3D asset 10 in the input set comprises a plurality of media component data subsets, each media component data subset containing different data for the source 3D asset. For example, each of the media component data subsets may comprise a point cloud, implicit surfaces like signed distance fields, volumes, constructive solid geometry, RGB-D images, spatial data structures (e.g. an octree), occupancy grids, 3D curves, 3D parametric surfaces, neural network weights that represent 3D data (such as neural radiance fields (NeRFs), for volumes), or mesh composed of vertices and polygons, where vertices are positions in 3D space in a 3D (x,y,z) cartesian coordinate space, and polygons are fragments of planes extending in the 3D (x,y,z) cartesian coordinate space (3D position in space) and polygons (3D polygon in space). The 3D assets can also comprise implicit surfaces such as a signed distance field. In a signed distance field each (x,y,z) position in space is assigned a value. Without loss of generality, a positive value can indicate that the (x,y,z) point is inside the 3D shape while a negative represents the exterior. A zero-level set would then be the 3D surface. Optionally, custom parameters such as weights indicating the importance of each piece of data can also be included in the remixing pipeline selector algorithm to allow for more fine tune control on the resulting new output 3D asset.

The input data 12 can also comprise a partial 3D asset and the present system can fill in the missing parts of the template or source 3D asset 10 according to the user input data. In one instance a separate remixer can deal with partial input, and the remixer could be selected by user parameters or user input data that is obtained from a front-end user interface (UI). Alternatively, the identification of the appropriate remixer can be inferred based on an analysis of the user provided asset(s), for example receiving text captions from rendered images of the 3D asset can be used to auto-select the right remixer. The output 3D asset can also be used again as part of user input data as the source 3D asset.

The remixing pipeline selector 14 receives the user input data 24 to a variety of remix pipelines, also referred to as remixers 16a-c, in a remixing engine 18, along with the media component data subsets in the source 3D asset 10 that is particular to each remixer. The remixing engine 18 comprises a variety of remixers, in this case remixer 1 16a, remixer N−1 16b, and remixer N 16c, where each remixer is associated with a different generative AI particular to a different media component aspect or dataset of the source 3D asset 10. Each remixer is a discrete GenAI system in which the input data or fragments thereof which are relevant to the particular remixer are provided for remixing of the media component data subset according to the input data. The output of the system is a new output 3D asset 22 which has some or all of its media components altered based on the user input data 24. Any media component which can be modified in a 3D model or 3D asset is considered a possible input to and output of a remix pipeline or remixer.

In one alternative method the source 3D asset 10 can be selected and/or generated by the system using user input data 24 only based on an existing set of source 3D assets 10 in a 3D asset database. In this implementation the user input data 24 is used to select one or more relevant source 3D assets 10 from the 3D asset database and the selected source 3D asset(s) 10 are used as input to the system. When more than one source 3D asset 10 is used as input to the system the media component data subsets for the multiple source 3D assets 10 can be combined together with the user input data 24. To select one or more appropriate source 3D assets 10 from the 3D asset database, a large language model (LLM) input can be used to convert user input data into a vector embedding to retrieve one or more relevant 3D assets, which is described in more detail in FIG. 11.

In each remixing pipeline or remixer, the user input data 24 and the subset of data pertaining to the remixer pipeline aspect or specific media component data subset from the input source 3D asset(s) 10 is remixed using the generative AI specific to that media component data subset. The remixer remixes that aspect of the source 3D asset 10 to produce a new 3D asset data structure for the particular media component of the 3D asset specific to the remixer. Once each of the remixers in the remixing engine 18 has generated the new 3D asset data structure for the particular media component associated with the remixer, a merging engine 20, which can be but is not limited to another generative AI or procedural system, merges the plurality of the new 3D asset data structures to create a coherent new output 3D asset 22. The individual generative AI and the overall system can perform a merging operation given the input assets with no guidance. The function of the merging engine 20 is for combining the generated individual remixed media components together to produce a single new output 3D asset 22. So, for example, given a remixed mesh, texture, and animation based on a source 3D asset 10 and user input data 24, the merging engine 20 would produce a single animated model.

The remixers, also called remixing pipelines, are the blocks which generate remixed media components for the new output 3D asset 22. The remixing pipelines can be run in serial or parallel. Additionally multiple pipelines for any given media component can be used together to create one or more bigger pipeline(s). For example, two or more texturing remixers can be used, with a first texture remixer to pre-condition the generated textures to contain certain objects and a second remixer to refine the output to a specific visual style.

The user input data 24 can be received by the system as, for example, a voice sample, text sample, a 3D asset, a 2D asset, an image such as a 3D image or a 2D image, text, video, audio such as speech and/or a sound effect, or motion such as a gesture and/or recorded motion. User input data can also be input as, for example, volumetric video, time-series data, tabular data, node graph data structures, and neural network weights that represent 3D data such as, for example, neural radiance fields for volumes. The incorporation of a large language model (LLM) to receive the user input data 24 and retrieve a contextually appropriate transformation to the 3D asset as desired by the user can then be applied to the various aspects of the input 3D asset(s) to generate a new output 3D asset 22.

The act of remixing of 3D assets is understood herein to comprise two separate processes which can be interwoven together. The first remixing process takes as input one or more 3D source asset(s) 10 which comprises a set of one or more media components and generates a new 3D asset as output 22 whose shape, appearance and animation is different from the source 3D asset 10 however representative of the input source 3D asset(s) 10 and also the user input data 24. In one example use, if the user input data consisted of the text “a furry dog”, the system can import a set of 2D images depicting a blue poodle. One or more of the set of imported 2D images of the blue poodle can then be used as the user input data 24. The source 3D asset can be selected by the system by vector embedding the text and/or 2D image supplied by the user to identify one or more relevant 3D assets from a 3D asset database that can be used as the source 3D asset 10 input to the system. Taking the identified 3D asset template as the source 3D asset 10 and the user input data 24, the remixing pipeline selector then segregates each media component data subset stream from the source 3D asset 10 into a different remixer in the remixing engine 18 to remix the media component data subset stream into a new remixed dataset for the specific media component of the new output 3D asset 22. In a second remixing process the merging engine 20 takes as input the remixed set of media components from the remixing engine 18 and outputs a new output 3D asset 22 which contains a remixed dataset of the media components of the source 3D asset 10 with the user input data 24. These processes are then interwoven when the outputs of the first remixing process are fed into the second remixing process and the outputs of the second remixing process can be fed back into itself as well as the first remixing process, which can accept any media component asset type. One plausible output of the remixing system would be a 3D asset where the mesh is shaped like a poodle and the textures would be that of blue fur.

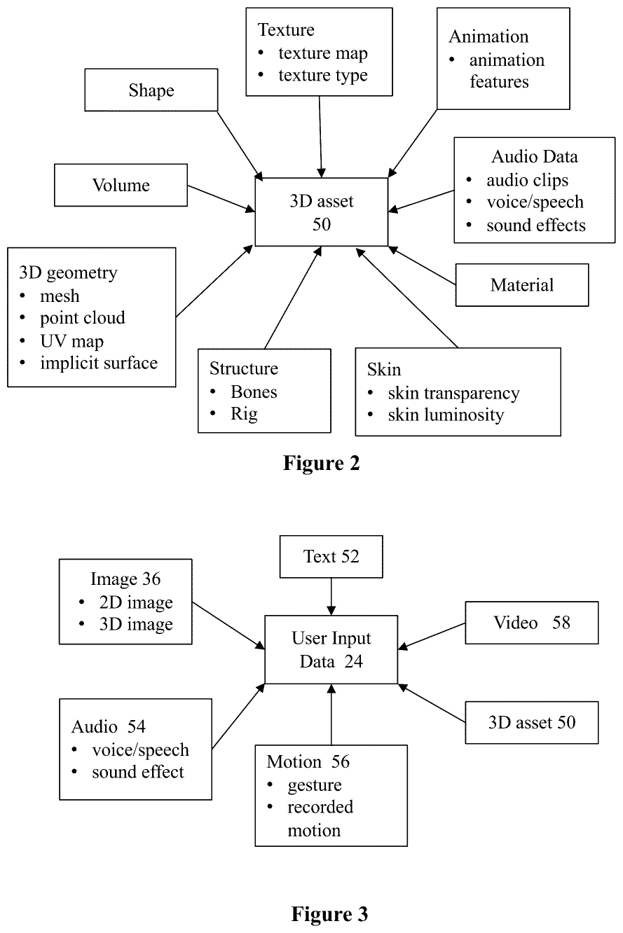

FIG. 2 illustrates different media components which can make up a 3D asset 50. Each of the media components that makes up a 3D asset 50 contributes media component data in the form of a media component data subset or subset to the whole set of data which describes the 3D asset. To create a new 3D asset, one or more media component data subsets from a source 3D asset are utilized, where each media component data subset contributes the data for a particular media component in the source 3D asset. In one example, the media component “shape” comprises a media component data subset describing the shape of the source 3D asset, which can be used to create a new 3D asset. In one embodiment, to remix a 3D asset, a base or starting 3D model or source 3D asset can be decomposed into its individual media components once it has been imported into the present system via an import library. Once the import is complete, each of the media components for each imported 3D asset, such as, for example, a mesh for shape, images for textures, audio clips, and animation or movement, is accessible and also replaceable and modifiable. The system can also accept a user uploaded source 3D asset, or the source 3D asset could be known to the system already because the media component came from a previous remixer or remixing process. Examples of different media components which a source 3D asset can contain include but are not limited to 3D mesh geometry, 3D point cloud geometry, 3D volumes, texture type, asset shape, texture, animation features, UV map, implicit surface description, 3D shape, audio data, animation data, structure such as bones and rig, texture maps (which are a type of image), and material properties. Materials are specific optical parameters of an object, for example, whether or not the 3D shape is shiny vs dull, transparent vs opaque. In one example, how “chrome” something is would not be defined in the image data because light interactions and reflections would not be captured in a static image, but may be defined as a material media component. Some specific aspects of the 3D asset which can be remixed independently can include but are not limited to the asset shape, texture including texture map and texture type, animation features, bones, rig, UV map, volume, skin including luminosity and transparency, voice, audio or sound effects, sound tonality and volume, and external effects such as asset-associated graphics or sound.

FIG. 3 illustrates different user input data that can be used as input to the present system and method. User input data 24 can comprise one or more of, for example, a 3D asset 50, an image 36 such as a 3D image or a 2D image, text 52, video 58, audio 54 such as speech and/or a sound effect, and motion 56 such as a gesture and/or recorded motion.

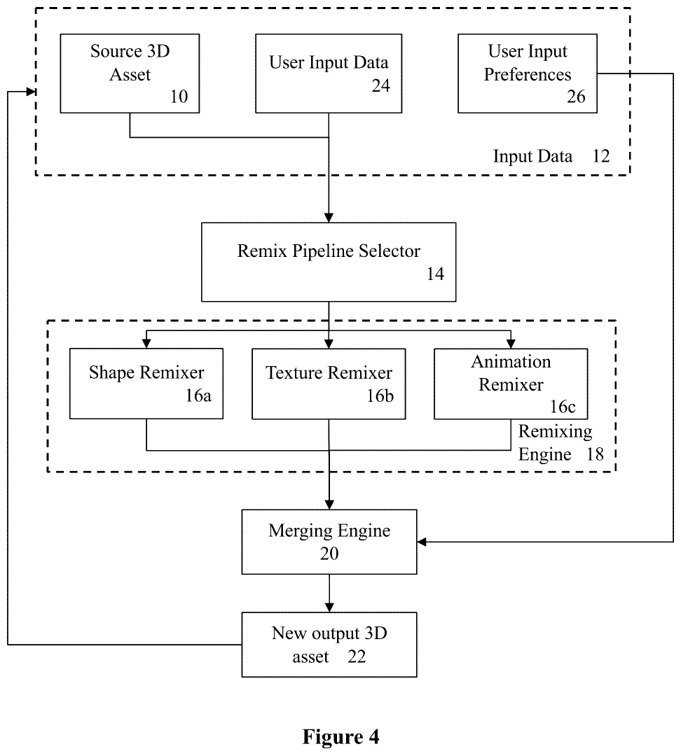

FIG. 4 depicts a flowchart of one specific example method of remixing a single source 3D asset 10 to create a new output 3D asset 22 using three media component remixers, specifically a shape remixer 16a, texture remixer 16b, and animation remixer 16c. The generative AI based remixing system takes the source 3D asset 10 as the base and the user input data 24 as the input data 12 and guidance to produce a new output 3D asset 22 which is a mixture of the media component data subset inputs of the source 3D asset 10 in terms of geometry or shape, appearance such as texture, and animation, but styled or modified by the unique user input data 24. In use, the system takes a source 3D asset 10 as input, extracts media component data subsets for the source 3D asset 10 where each data subset pertains to a different media component, in this case specifically one of shape, texture, or animation, and sends each data subset through a remixing pipeline selector 14 different generative AI remixer 16a, 16b, 16c in a remixing engine 18, where each remixer is specific to the media component data subset. In the embodiment shown, the remixing engine comprises a shape remixer 16a which receives shape data from the one or more 3D asset, a texture remixer 16b which receives texture data from the one or more 3D asset, and an animation remixer 16c which receives animation data from the one or more 3D asset. Each different remixer, which comprises a generative AI, takes the specific media component data subset from the source 3D asset 10 and remixes it together with the user input data 24 to produce its own respective new 3D asset dataset pertaining to the specific media component, i.e. shape, texture, animation. The merging engine 20 is a fourth generative AI which is then used to merge the results from the shape remixer 16a, texture 16b remixer, and animation remixer 16c into one coherent new output 3D asset 22.

In the first remixing process a set of one or more media component assets of an input source 3D asset 10, such as, in this example, shape, texture, and animation, is input independently into its specific remixer along with the user input data in an embedded vector format. Each remixer then provides a new output dataset for the media component. The merging engine then combines the output of each individual remixer, optionally according to an applied weighting to provide the new output 3D asset. The new output 3D asset 22 then has a shape, appearance and animation representative of the source 3D asset, however each media component of the source 3D asset has been modified by the GenAI system in accordance with the user input data in each remixer and also in the merging engine 20. Each individual remixer and the overall system can also perform a remixing process given only the input source 3D asset 10 with no additional guidance. If no unique user data is provided, the generative AI system can use the input asset as the guidance so that the style is also derived from the one or more input source 3D asset 10. This can be done using random weighting and other random input data such that the new output 3D asset 22 is different from the source 3D asset 10.

A variety of vector embedding blocks and operations can be used in the present remixing pipelines depending on the type of data input. To build each remixing pipeline or remixer the following blocks can be combined: 1) a vector embedding function; 2) a data pre-processing function; 3) a generative AI (GenAI) system(s); 4) a data post-processing function; and 5) a data combination function.

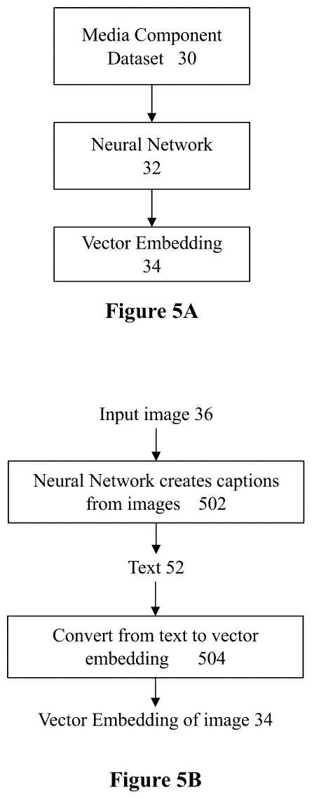

FIG. 5A is a flowchart depicting a general example of a vector embedding block using a generic media component data subset as input. The input media component data subset 30 is imported into a neural network 32, which converts the media component data subset into a vector embedding 34. The resulting vector embedded dataset for the media component can then be used as input to a remixer in the remixing system.

FIG. 5B is a flowchart depicting an example vector embedding block using an input image 36. The present system can receive an input image as user input data to remix a 3D asset. To do this, an input image 36 can be imported into a neural network, where the neural network creates a caption or text 52 for the input image 502. The caption output text is then converted from text to a vector embedding 504 to produce a vector embedding of the input image 34. The vector embedding of the image 34 can then be used as input to a remixer in the remixing engine.

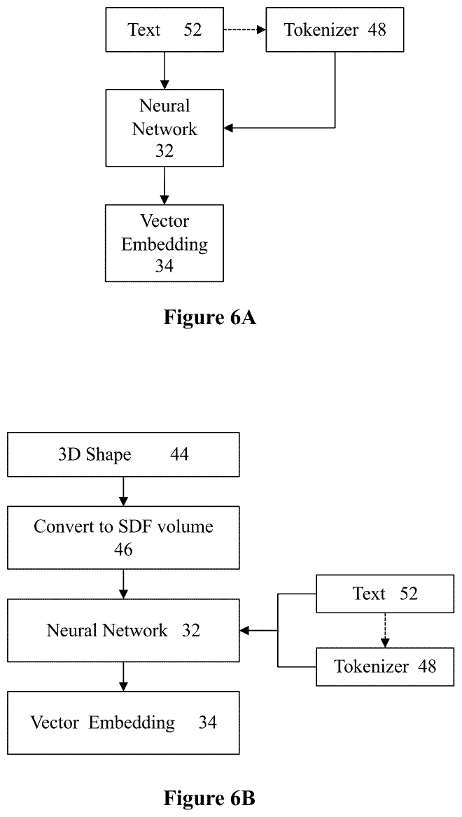

FIG. 6A is a flowchart depicting a vector embedding block using text as input. The vector embedding function block transforms the raw input user data as text 52 into an array of numbers. Specifically how this data transformation is done is often application and domain specific. For example, in natural language processing (NLP), textual data like sentences and paragraphs can be converted to vector embeddings using the Word2Vec algorithm or similar. In a vector embedding the input is converted into a list or multi-dimensional array of numbers using a conversion algorithm. For applications in image processing, an encoder neural network like those found in generative adversarial networks (GANs) can be used to downsample input images via trainable neural network layers until a smaller block of numbers is obtained. In the case of GANs, this smaller block of numbers is the vector embedding, also called latent vector. The main objective of these vector embeddings in the present system is to allow for custom types of similarity to be computable. In one example, OpenAI's CLIP model was trained on image+text caption pairs found via scraping the internet. As a result, it is able to compare vector embeddings of images to vector embeddings of text and answer the query “how accurately does the text describe the image?”. The tokenizer 48 converts an arbitrary length input sequence (e.g. text, sequence of pixels, etc.) into more manageable blocks of data. Similar to vector embedding algorithms, precisely how tokenization is done is domain specific. For example, in NLP a tokenizer could split the input text into words, groups of words or subwords. In image processing it could be splitting a large image into smaller pieces. Once tokenized these sub-blocks of data (also called a token) can be fed into a neural network 32 and vector embedding 34 algorithm to obtain an embedding per token or one single combined embedding.

FIG. 6B is a flowchart depicting a vector embedding block using an input 3D shape 44 to create a vector embedding 34 of the 3D shape 44 input. The 3D shape 44 input is first converted to an intermediate presentation such as a Signed Distance Field (SDF) volume. The SDF volume 46 is a data format that stores distance values in a 3D texture, where the distance values are a measurement of how far away a sampled position is from a surface. The SDF volume is then imported into a neural network 32, optionally with input text 52 that has been subject to a tokenizer 48. The SDF is downsampled via the neural network 32 layers until it is a block of numbers of a specific size and dimension. The text 52 is also fed into the neural network 32 which will have the appropriate inputs which accept text data. This text 52 data is also passed through the neural network 32 and transformed into a block of numbers much like a vector embedding. The final output vector embedding 34 is found by combining the two blocks of numbers via a vector operation (e.g.: addition, multiplication, concatenation, etc.), optionally by applying a series of neural network layers before obtaining the final vector embedding as the output of the neural network.

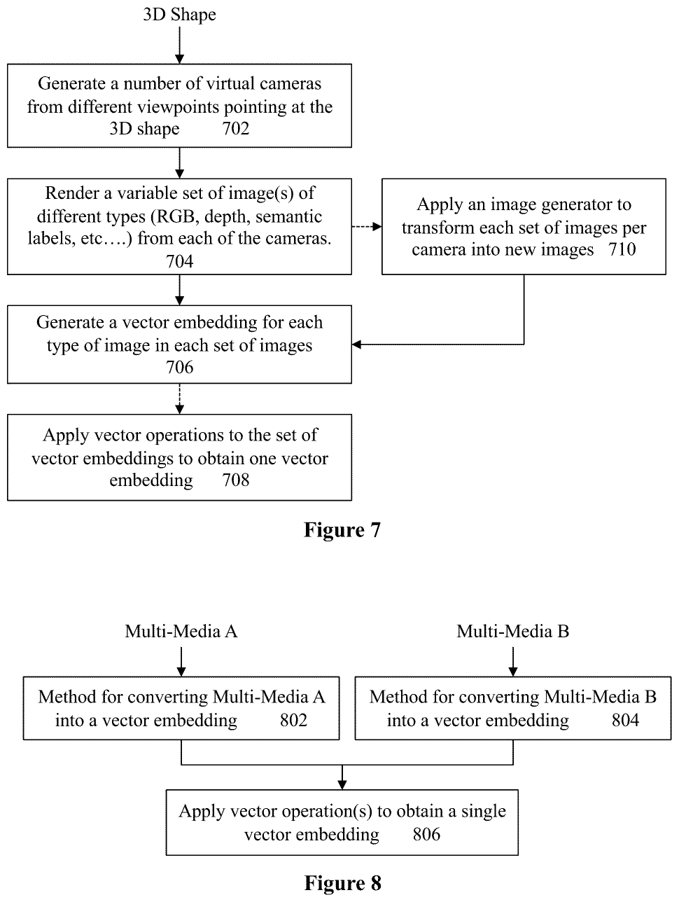

FIG. 7 is a flowchart depicting an example vector embedding generation method block using a 3D shape as input with using virtual cameras. A 3D Shape 44 is used as input. A plurality of virtual cameras are then generated from a plurality of different viewpoints pointing at the 3D shape 702 to capture the image at the various viewpoints. From the various viewpoints a set of images is rendered of different types (RGB, depth, semantic labels, etc.) from each of the virtual cameras 704. An image generator is then applied to transform each image from the set of images for each camera into new images 710. This transformation can be done via image operations like sharpening, smoothing, highlighting edges, colorization via image segmentation or via a neural network that takes as input an image and outputs another image or via a GenAI system that accepts images and optional user data as input and outputs another image. A vector embedding is then generated for each image type (RGB, depth, semantic labels, etc.) of image in each set of images 706. The image type is defined as above. These can include RGB, depth, semantic labels, etc. When rendering an image of a 3D model the system can render different image types. In some examples, the pixel could be the RGB value of the texture at that point, it could be the distance (depth) to the camera, or it could be a label in the case of a labelled mesh (e.g. each vertex/face is labelled). The data format is the same, at a (x,y) location is a single number (depth) or a tuple of numbers (RGB). Having multiple image types can often improve the output, e.g. the output image can follow the contours of the input depth map while the artistic style can be drawn from the input RGB image. A vector operation can then be applied to the set of vector embeddings to obtain a single vector embedding for the input 3D shape 708.

FIG. 8 is a flowchart depicting an example of mixing two different media types into one vector embedding. Multi-Media A and Multi-Media B are each any media type that the present system is capable of accepting as input. Note that Multi-Media A and B can be the same types of media inputs and they can also be different types of media input. There is no restriction nor coupling between A and B. A method for converting Multi-Media A into a vector embedding 802 is applied and a method for converting Multi-Media B into a vector embedding 804 is applied. Once a vector embedding is found for each of Multi-Media A and Multi-Media B, one or more vector operations are then applied to obtain a single vector embedding 806 for the multi-media input.

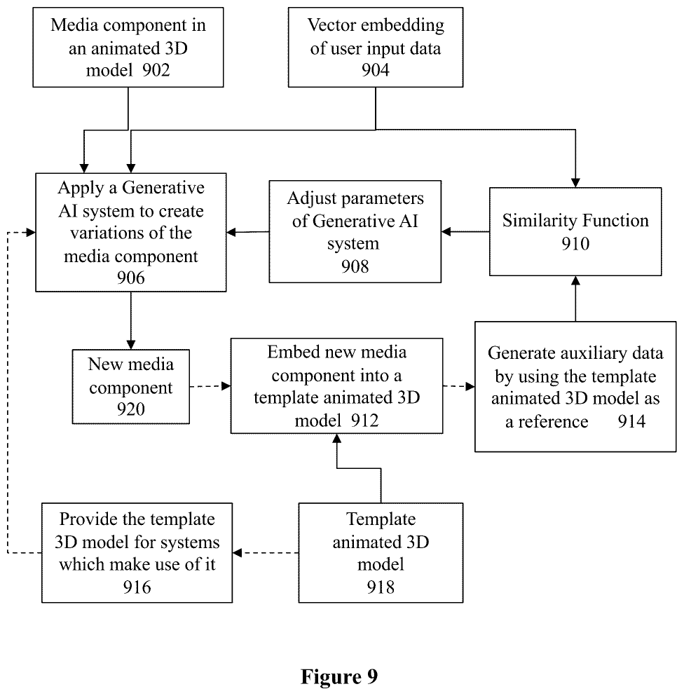

FIG. 9 is one example of a remixing pipeline or remixer. The remixer receives a media component which is one media dataset component of the animated 3D model or 3D source asset 902. The media component from the 3D source asset and a vector embedding of user input data 904 are imported into a generative AI system in the remixer to create variations of the media component 906. The vector embedding of the user input data can also be used as an input to a similarity function 910 which can then adjust parameters of the generative AI system 908 and then used as an alternative or additional input to the GenAI function in the remixer. The remixer can then create a new media component 920 which can then be sent to a merging engine to merge other newly created media components to generate a new 3D asset. The new media component can also be optionally embedded into a template animated 3D model 912 to generate auxiliary data by using the template animated 3D model as a reference 914 which can be further fed back into the similarity function. Additionally or alternatively, a template animated 3D model 918 can be used as input to create the new embedded media component and provided for use in systems to make use of the new media component 916. Iterative updates to the GenAI system can thereby be based on the new generated media components to create entirely new 3D assets.

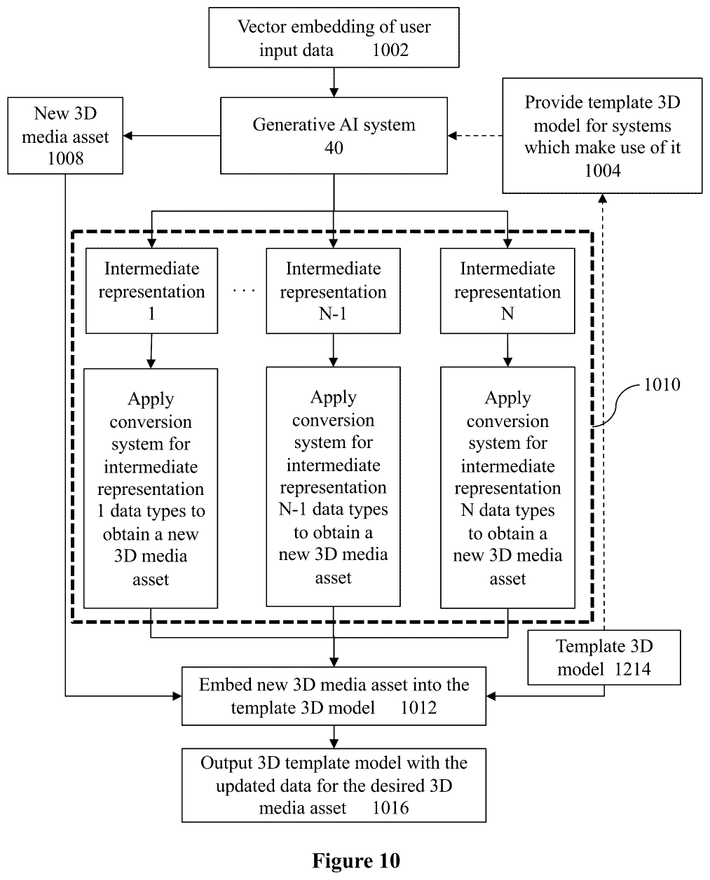

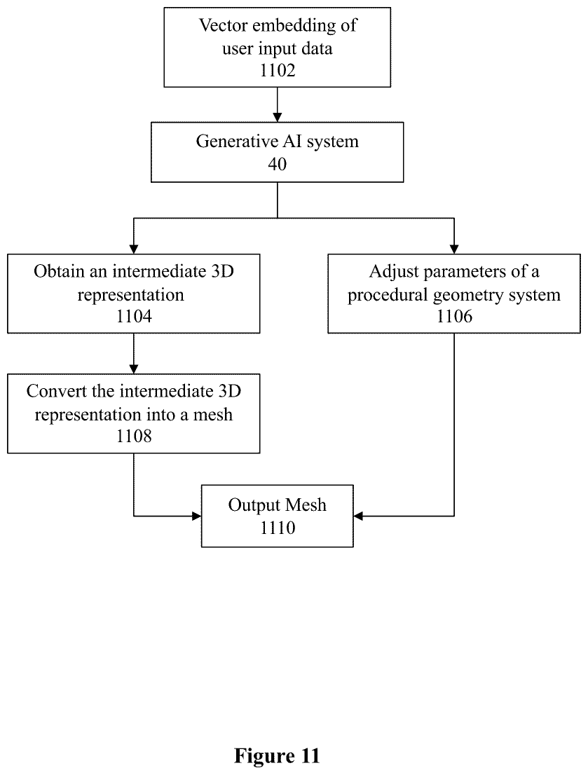

FIG. 10 is an example of creation of a template 3D model using a generative AI remixer to create a new 3D asset using a template 3D model 1014. From a vector embedding of user input data 1002 the generative AI system can either create a new 3D media asset 1008 as previously described, or create a plurality of intermediate representations of a new 3D asset which can be used to create a new template 3D model 1014. Specifically, the GenAI system 40 converts the vector embedding of the input user data and optionally with additional data provided by a template 3D model into either the exact media asset type that is desired or an intermediate representation. Each of the intermediate representations in a subsystem for conversion of a set of intermediate representations 1010 then applies a custom post-processing block to transform the intermediate representation into the same type of media asset as the desired output. Using one or more of the new 3D media asset 1008, the template 3D model 1014, and the one or more of the converted intermediate representations, the system can embed a new 3D media asset into the template 3D model 1012 and output the 3D template model with the updated data for the desired 3D media asset 1016.

FIGS. 11-19 show various examples of specific remixing pipelines for different media component data types which are found in 3D models. A key component in each of these remixing pipelines is the generative AI system. The exact GenAI system used depends on the pipeline. Although FIGS. 11-19 show examples of only three different media component data types, specifically 3D geometry, textures, and animation, it is understood that a wide variety of other and different media component data types which are found in 3D assets are also possible for remixing through the generic pipeline as shown in FIG. 9.

FIG. 11 is an example of the identification of a mesh using user input data and remixing with a generative AI system 40. If there is no user input data to the remixing system a source 3D asset or template 3D asset can be selected by the system to create a new 3D asset using only the user input data and vector embedding thereof. In this case the user input data can include only text or alternatively any other user input data or combination of user input data types. The user input data is converted into a vector embedding 1102 and input into a generative AI system 40 to obtain an output mesh 1110 that can be used as a template 3D asset. To do this, the generative AI obtains an intermediate 3D representation 1104 and converts the 3D representation into a mesh 1108. Concurrently the parameters of a procedural geometry system can be adjusted 1106. An existing procedural geometry system can also be used, for example a tuned generative pre-trained transformer (GPT) type model can be the GenAI system which would output the parameter values for the procedural geometry system. To directly generate a mesh from text the system can also make use of pre-trained neural networks like GANs. The combined output mesh 1110 can then be used as a media component input for a remixing system to generate a new 3D asset. In particular, this newly created templated output mesh can then be carried through to the rest of the system and modified in accordance with the user input to produce a new 3D output asset.

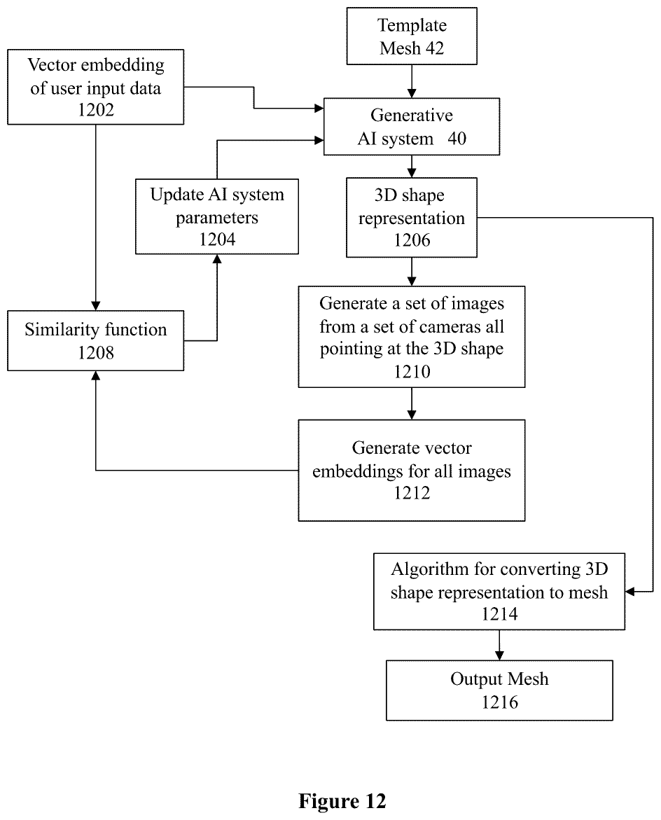

In FIGS. 12-14 three possible remixing pipelines are provided for generating a new output mesh given some user input data and a template mesh. The GenAI system utilized can include but is not limited to 3D GANs, a combination of image generators and 3D diffusion models and procedural generation systems. Note that the output mesh from these remixing pipelines can become the template mesh for a subsequent generation request. A combination of one or more of the presently described blocks creates a remixing system in which user-provided input data can flow through to produce specific media component types that are found within 3D models. These variations on remixing pipelines can be used in the presently described remixing system and method to generate a multitude of new 3D assets with a mixture of independently remixed media components using generative AI.

FIG. 12 is an example of a remixing pipeline that takes user input data and a template mesh to generate a new 3D output mesh 1216. This is a specific example of FIG. 10 where the new media asset of interest is the 3D geometry of a 3D model and the method to obtain it is via an iterative process that informs and updates the GenAI system. In this example, the method of update is via a similarity function 1208 based on the vector embedding representation of the user input data 1202. The GenAI system 40 block is a generic block to indicate that a GenAI neural network or algorithm is used to generate new data. Examples of a GenAI block include but are not limited to pre-trained neural networks, procedural generation systems and domain specific algorithms. In this example the similarity function 1208 receives a vector embedding of user input data 1202 which is used to update the AI system parameters 1204. The GenAI system 40 then creates a 3D shape representation 1206 and generates a set of images from a set of cameras pointing at the 3D shape 1310 and generates a vector embedding for all images 1212. Alternatively, the 3D shape representation 1206 can comprise multiple meshes, multiple point clouds, or sign distance fields, and an algorithm can be used to convert these into a single mesh or multiple meshes for rendering images. An algorithm for converting the 3D shape representation to the mesh is applied 1214 to generate the output mesh 1216.

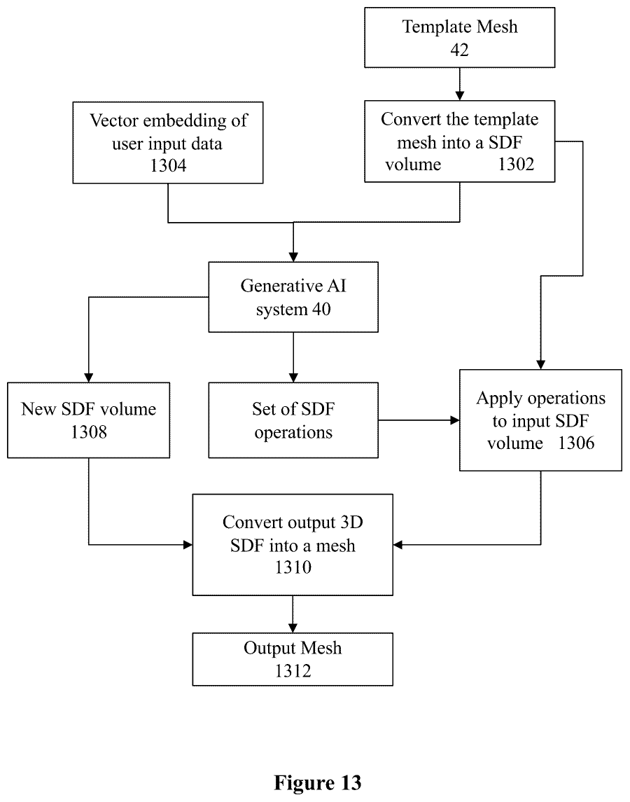

FIG. 13 is another example of a remixing pipeline that takes user input data and a template mesh to generate a new output 3D mesh. This is a specific example of FIG. 9 where the GenAI system 40 uses intermediate representations to obtain a 3D mesh. In this example a template mesh 42 is converted into a template mesh SDF volume 1302 and the template mesh SDF volume and vector embedding of user input data 1304 is imported into a generative AI system 40 which functions as a remixer. The generative AI system creates a new SDF volume 1308 and/or a set of SDF operations 1314 as the intermediate representations. In the case of the new set of SDF operations 1314, they can be applied to the input SDF volume 1306 to create a new SDF volume variation. In the case where both paths are run in parallel, the two SDF volumes can be merged through a SDF union operation right at the start of the converter block. The new SDF volume can then be converted into a new 3D mesh 1310 and the new output mesh 1312 can be imported into a remixing system for contributing a new mesh as a media component to create a new 3D asset.

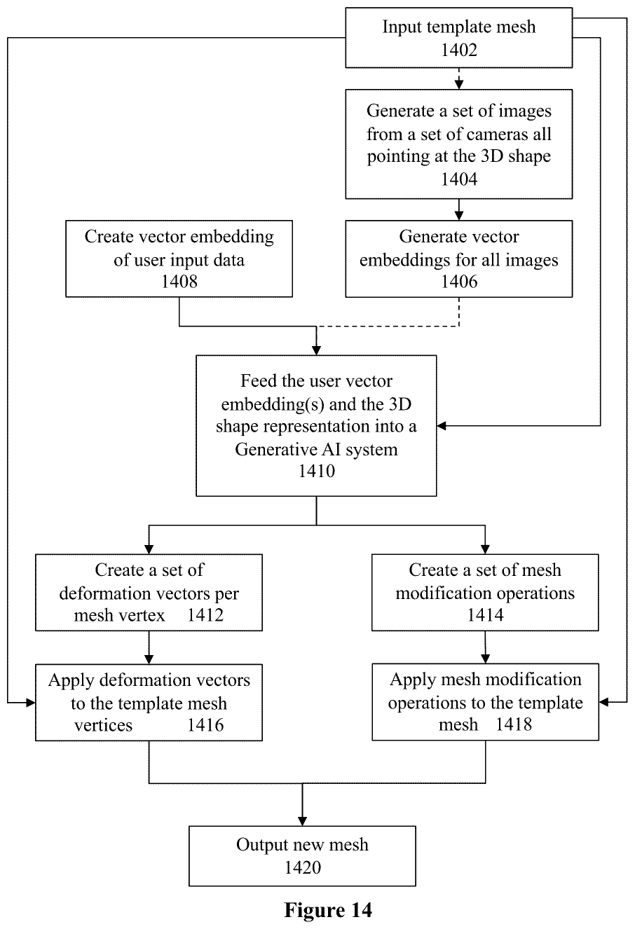

FIG. 14 is an example method of a remixing pipeline that takes user input data and a template mesh to generate a new 3D mesh. This is a variation of FIG. 13 with additional pre and post-processing steps to accommodate the different intermediate data structures. The data pre and post-processing blocks process the data before it goes through a GenAI system and after, respectively. In this example, an input template mesh 1402 is used to generate a set of images from a set of cameras all pointing at the 3D shape 1404, and a vector embedding for all images is then generated 1406. This is combined with one or more created vector embedding of user input data 1408 and the vector embedding(s) of user input data and the vector embedding(s) of the 3D shape representations are fed into a Generative AI system 1410. The GenAI system then creates a set of deformation vectors per mesh vertex 1412 and creates a set of mesh modification operations 1414. The set of deformation vectors are then applied to the template mesh vertices 1416, and the mesh modification operations are applied to the template mesh 1418. The modified template mesh vertices and template mesh are then combined to create an output new mesh 1420.

Other examples of pre-processing steps that can be applied can include but are not limited to appending additional text to textual data inputs, applying image filters, and data smoothing. Examples of post-processing steps can include but are not limited to extracting a mesh from a volume, taking multiple images of a 3D shape and data smoothing. Note that some algorithms can be applied in both pre and/or post processing blocks. A data combination block such as that shown in FIG. 4 can also be applied at the end, taking as input multiple media component types (e.g. meshes, texture maps, animation clips, etc.) to generate a single 3D model as output.

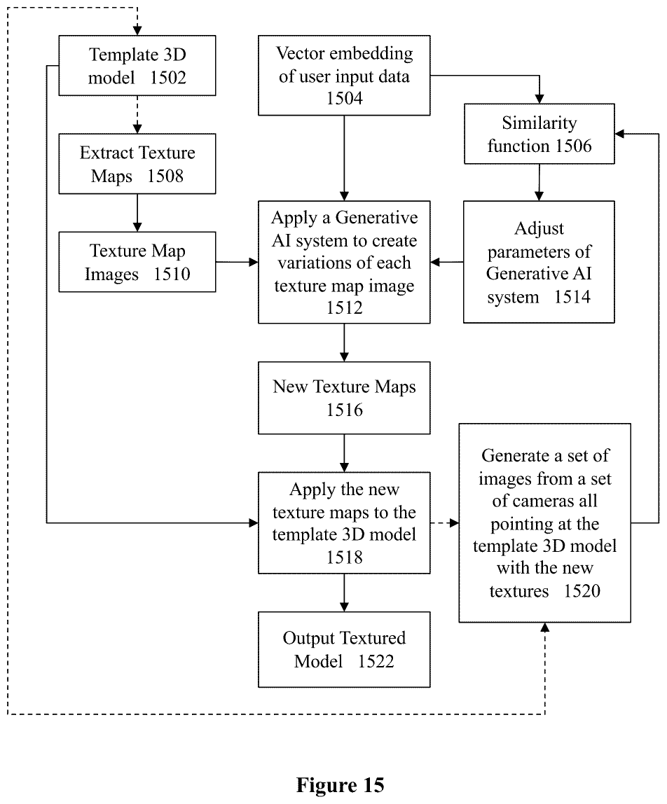

FIGS. 15, 16, and 17 are examples of remixing pipelines that receive user input data and a template 3D model to create a new output textured model. These illustrated systems are similar to remixing pipelines previously illustrated in the present invention, but adapted to a specific media component type, in particular the texture map. The individual components in the remixing pipeline comprising a GenAI are changed to support that media component type. In particular, the algorithms in the remixing pipelines in the present remixing in the pre and post-processing stages are specific to the media component data type of the specific remixer and different methods are needed for each. The template model or input 3D asset to the remixing system, which serves as input to a remixing pipeline, may or may not have a texture already. Generally, the input 3D asset or starting 3D template may have certain media component data types, but not others, and the output 3D asset desired may require a media component data type that does not exist in the starting 3D asset. In the case where the template 3D model or source 3D asset has a texture, the system can receive the texture of the template 3D model and modify the texture data according to the input user data to generate a new output 3D model that is textured. In the case where the template 3D model does not have a texture, the remixing pipeline shown can extract a texture map according to the user input data and the remixer output can generate a new 3D model that is textured, creating a new media component data type for the output 3D asset that was not part of the input source 3D asset. Specifically, in the case where there is no starting texture information associated with the user input data the remixer can extract existing texture maps from a selected template 3D model. Thus a suitable texture map can be provided to the GenAI system of the remixing pipeline for texture (texture remixer) without needing the template 3D model to have textures itself. In the case where the texture map is not given as part of the user input and not found as part of the template 3D model data, then one can be generated by sampling the vertex colors of the mesh. More specifically, the system can exploit the mapping between the texture pixel data and where it would be placed on the 3D model for rendering to find the closest vertex of the mesh to sample a color for every pixel in the texture map. In the cases where the mesh has no vertex color, the system can generate them by segmenting the mesh into discrete regions and assigning a unique color per region. All vertices in the same region would have the same color. The GenAI system utilized can include but is not limited to pre-trained image generators, image based GANs, and style transfer networks.

FIG. 15 is a flowchart depicting an example of a remixing pipeline that takes user input data and a template model to generate a new textured 3D model. This is a specific example of FIG. 9 where the new media asset of interest is the texture map of a 3D model and the method to obtain it is via an iterative process that also informs/updates the GenAI system. In this example, the method of updating the vector embedding of user input data is via a similarity function. To do this a vector embedding of user input data 1504 is provided to a similarity function 1506 to which the parameters of the GenAI system can be adjusted 1514. In one embodiment, the vector embedding of user input data 1504 is also provided to a GenAI system to create variations of each texture map image 1512 based on texture map images 1510 that were extracted from texture maps 1508 optionally as a part of a template 3D model 1502. In an alternative, the set of virtual cameras can take images of the template 3D model to obtain a representation of the textures 1520 which then can replace blocks 1508 and 1510 to obtain visual data of the textures in the template 3D model, which can be used as texture input to the remixer. New texture maps 1516 can then be created by the GenAI system which can be applied to the template 3D model 1518 to provide an output textured model 1522. Additionally and optionally, a set of images can be generated from a set of cameras pointing at the template 3D model with the new textures 1520 which can be provided back to a similarity function 1506.

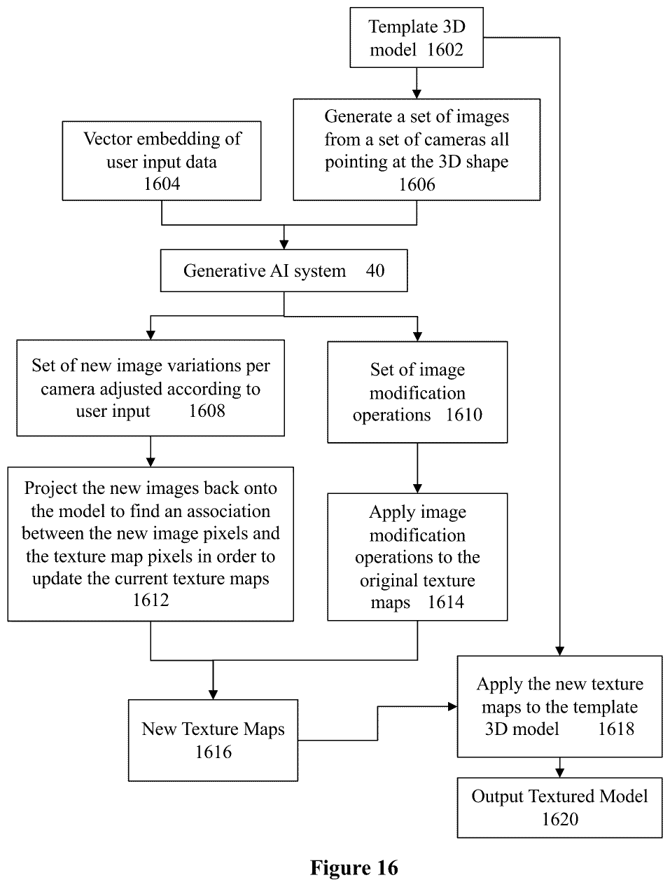

FIG. 16 is a flowchart depicting another example of a remixing pipeline that takes user input data and a template model to generate a new textured 3D model. This is a specific example of FIG. 9 where the GenAI system uses intermediate representations to obtain a 3D mesh. In this example a template 3D model 1602 is used to generate a set of images from a set of cameras all pointing at the template 3D model shape 1606. This set of images and a vector embedding of user input data 1604 is then provided to a generative AI system 40 which creates a set of image modification operations 1610 and a set of new image variations per camera adjusted according to user input 1608. The new images are then projected onto the model to find an association between the new image pixels and the texture map pixels in order to update the current texture maps 1612 and the image modification operations are applied to the original texture maps 1614 to create new texture maps 1616. The new texture maps are then applied to the template 3D model 1618 to provide a new output textured model 1620.

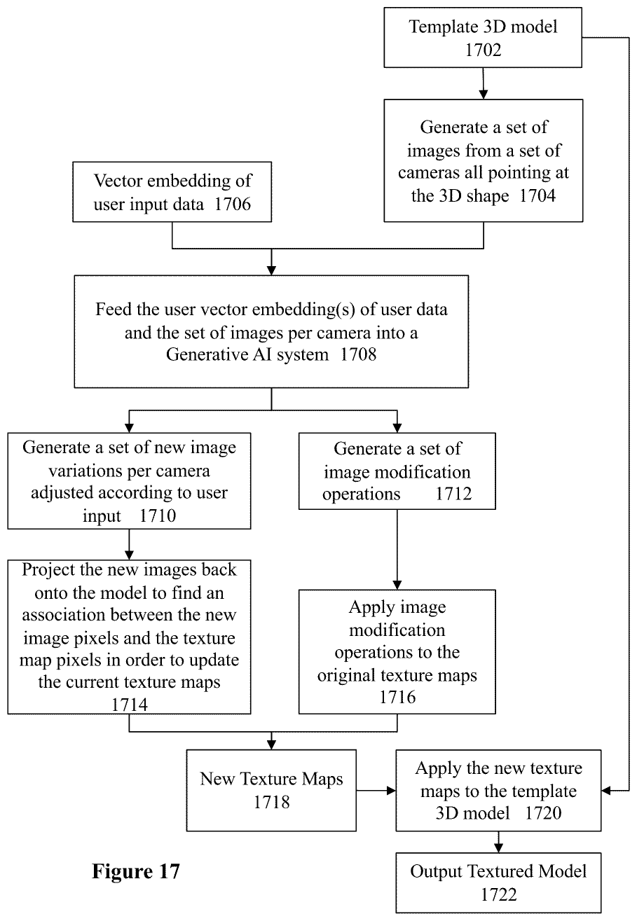

FIG. 17 is a flowchart depicting another example of a remixing pipeline that takes user input data and a template model to generate a new textured 3D model. A variation of FIG. 14 with additional pre and post-processing steps to accommodate the different intermediate data structures. In this example a template 3D model 1702 is used to generate a set of images from a set of cameras all pointing at the 3D shape 1704. A vector embedding of user input data 1706 is also created from user input data. The user vector embedding(s) of user data and the set of images per camera are then fed into a generative AI system 1708 and a set of new image variations is generated per camera adjusted according to user input 1710 along with a set of image modification operations 1712. Image modification operations are then applied to the original texture maps 1716 in the template 3D model. The new image variations from each the can then be projected back onto the template 3D model to find an association between the new image pixels and the texture map pixels in order to update the current texture maps 1714. The updated texture maps and image modifications can then be combined to create new texture maps 1718, and the new texture maps can be applied to the template 3D model 1720 to create a new output textured model 1722.

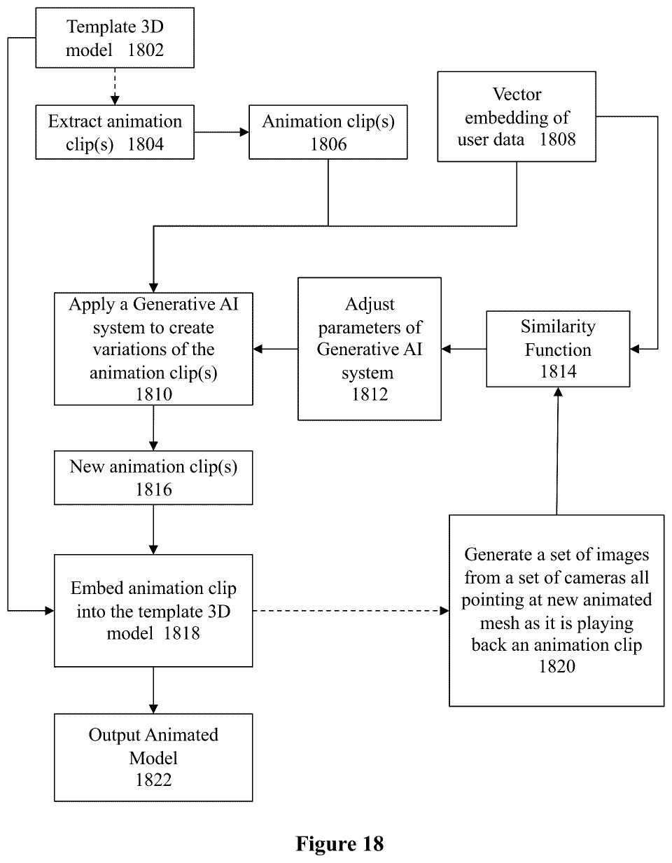

FIG. 18 is a flowchart depicting an example of a remixing pipeline that take user input data and a template model to generate a new animated 3D model. In this way, a new media component data subset, in this example an animation media component, can be added to a source 3D asset where that media component (i.e. animation) was not one of the media component data subsets in the source 3D asset or the user input data. In particular, a non-animated source 3D asset can be animated by mixing a media component dataset for animation from a template 3D model with the source 3D asset using the present system. A source 3D asset may or may not have animation clips attached to it already, but animation clips can be extracted 1804 from the template 3D model 1802. The extracted animation clips 1806 and a vector embedding of user data 1808 can be applied to a generative AI system to create variations of the animation clip(s) 1810. The vector embedded user data 1808 can also be fed into a similarity function 1814 and the parameters of the generative AI system adjusted 1812 which can be applied to create the animation clip variations. For example, a user input of “angry” to describe a 3D asset could be applied to create an animation with jerky motions and suitably expressive angry gestures. The system can then create one or more new animation clip 1816 which can be embedded into the template 3D model 1818 to create a new output animated model 1822. From the animated template 3D model with new embedded animation clip a set of images from a set of cameras all pointing at new animated mesh can also be generated as it is playing back an animation clip 1820. The GenAI animation remixer illustrated is a remixing pipeline adapted to create a new media component type, specifically animation clips, for a source 3D model together with user input. This is a specific example of FIG. 9 where the new media component of interest is at least one animation clip that can be applied to a source 3D asset and the method to obtain it is via an iterative process that also informs and/or updates the GenAI system. In this example, the method of update is via a similarity function based on the vector embedding representation of the output data. The GenAI system utilized can include but is not limited to diffusion models, time-series GANs, and procedural animation systems.

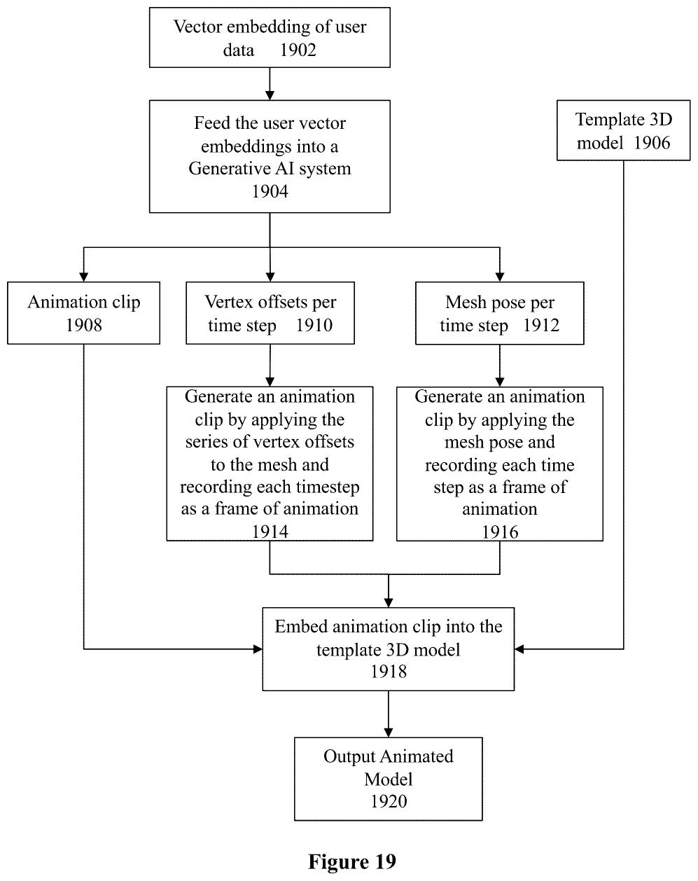

FIG. 19 is a flowchart depicting another example of a remixing pipeline that takes user input data and a template model to generate a new animated 3D model. The template 3D model 1906 may or may not have animation clips attached to it already. In this particular example the GenAI system uses intermediate representations to obtain animation clip data. This example includes vertex offsets and mesh posing as possible data representations that can create animation clip data. In this example, a vector embedding of user data 1902 is created, and the vector embedding is fed into a Generative AI system 1904. The GenAI system then extracts at least one animation clip 1908, vertex offsets per time step 1910, and mesh pose per time step 1912. The system then generates an animation clip by applying the series of vertex offsets to the mesh and recording each timestep as a frame of animation 1914 and/or generates an animation clip by applying the mesh pose and recording each time step as a frame of animation 1916. The animation clip and/or animation frames are embedded as animation clips into the template 3D model 1918 to produce a new output animated model 1918.

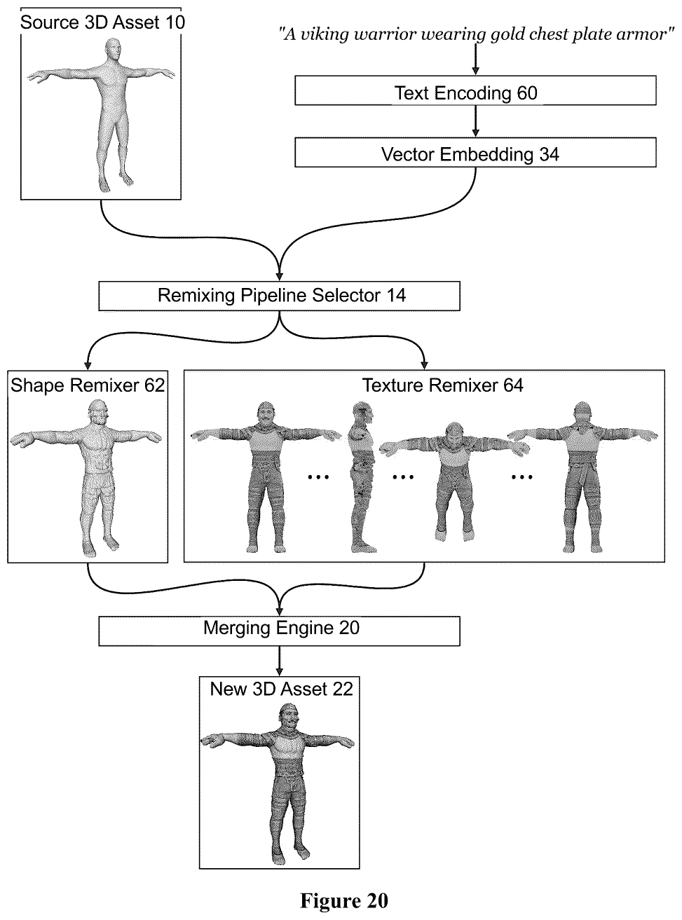

FIG. 20 is a flowchart with graphical illustration of an example of generation of a new 3D asset from a source 3D asset having geometry. In this example, user input is received as a piece of text “a viking warrior wearing gold chest plate armor” describing the desired output. The user text input is put into a text encoding 60, followed by vector embedding 34. The vector embedding of the user input is received into a remixing pipeline selector 14 together with a source 3D Asset 10. The remixing pipeline selector 14 directs the asset and input into a shape remixer 62 and also a texture remixer 64. The output is received by a merging engine 20 to generate a new output 3D asset 22. The source 3D asset 10 in this example has geometry but no texture, and the texture remixer 64 applies texture to create an output 3D asset with texture. The input 3D asset 10 is modified by the shape remixer 62 to add details related to the text prompt (e.g. armor) and the input 3D asset 10 is also used by the texture remixer to generate multiple images representing different viewpoints. The merging engine 20 takes the new data and produces a new final 3D asset 22 with a new shape and appearance that matches the multiview images produced by the texture remixer 64. It is noted that the texture is generated by the texture remixing system 64 and applied by merging engine 20 as the source 3D asset does not have texture.

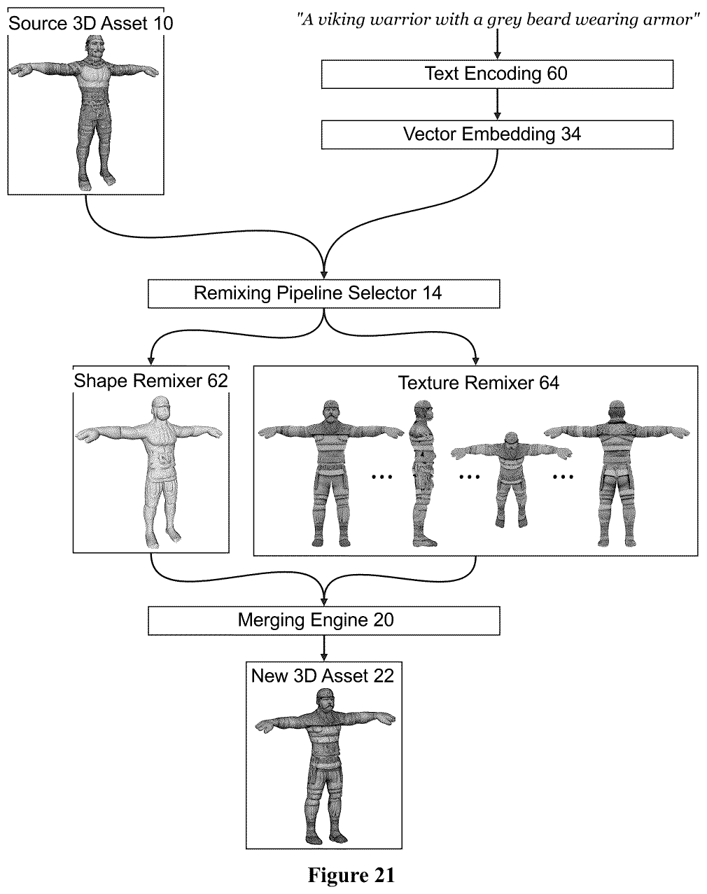

FIG. 21 is a flowchart with graphical illustration of generation of a new 3D asset from a source 3D asset having geometry and texture. The source 3D Asset 10 in this example has both geometry and texture and is remixed with a text input that has been subject to text encoding 60 and vector embedding 34. The remixing pipeline selector 14 directs the user input and data from the source 3D Asset 10 into a shape remixer 62 and texture remixer 64, and the remixing product is then sent to a merging engine 20 to produce a new output 3D asset 22. In this case both the texture and the shape has been remixed and combined in the merging engine 20 to create the new output 3D asset 22.

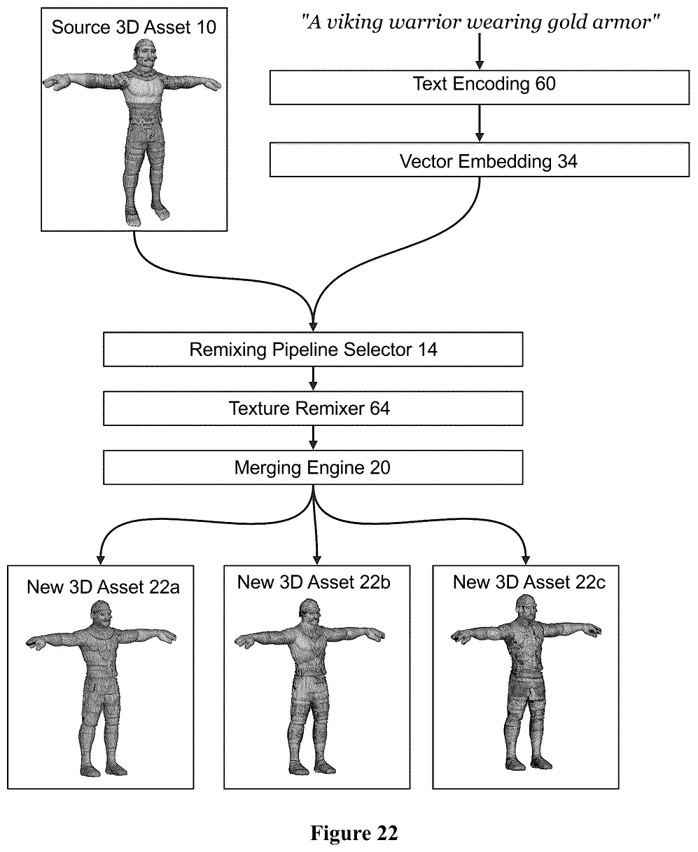

FIG. 22 is a flowchart with graphical illustration of generation of three new 3D asset from a source 3D asset with texture remixing but retained shape. In this example the source 3D Asset 10 is remixed with a text input that has been subject to text encoding 60 and vector embedding 34 and only the texture is remixed. The remixing pipeline selector 14 receives the vector embedded user input data together with the source 3D asset 10 and received in a remixing pipeline selector 14. The texture remixer 64 remixes the texture and puts the remixed textures into a merging engine 20 to create a plurality of new output 3D assets 22a, 22b, 22c which are multiview images. The internal view of the multiview images is not shown for brevity. The plurality of new output 3D assets 22a, 22b, 22c illustrates that the present system can generate a number of variations of new 3D assets via multiple runs and random seed numbers.

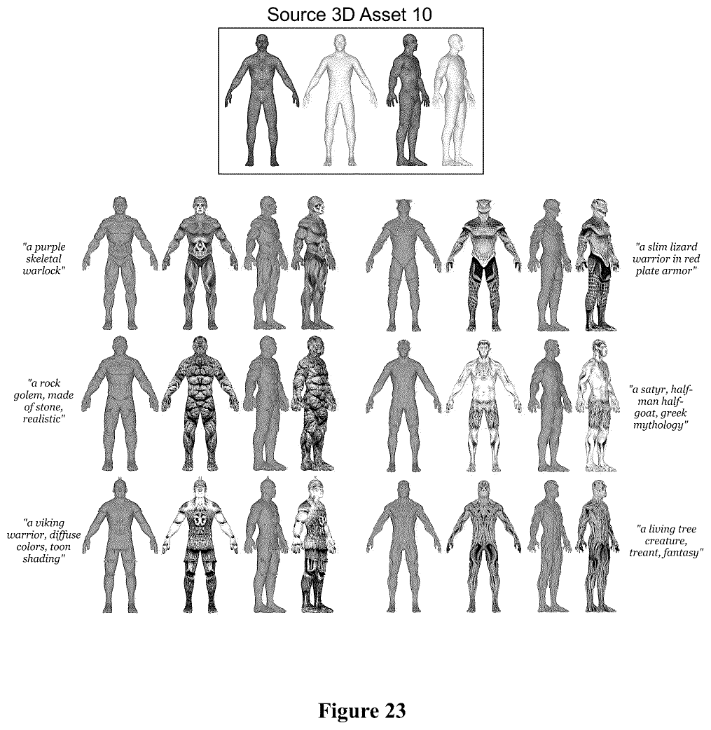

FIG. 23 is an illustration of a plurality of new 3D assets generated from a source 3D asset 10 with different input data. At the top row is the template input source 3D asset model that was used to generate all six example outputs underneath the top row from different text user inputs. The wireframe and two perspectives, front and side, are shown for the input template. The six example models were generated by one embodiment of an implementation of the present remixing system. Two perspectives for each output model are shown: the front view and a half-side view. For each viewpoint, the model is visualized in two ways: (1) just the deformed geometry with no textures and (2) full textures and the deformed geometry. Additionally, the text prompt used to generate the model is shown on the far sides of each model.

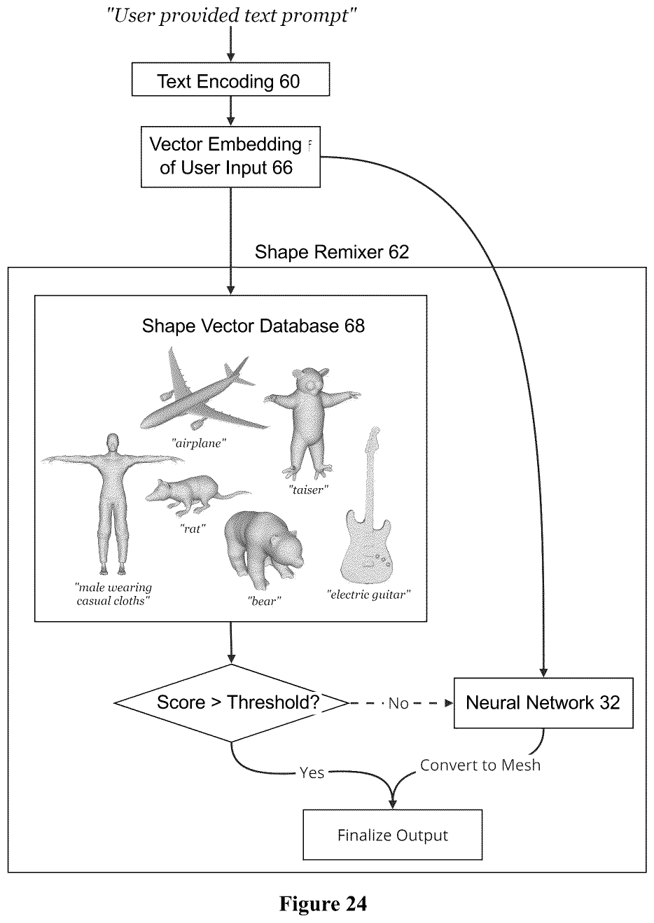

FIG. 24 is a flowchart of an embodiment of a shape remixer using a shape vector database. In this embodiment a shape vector database 68 of shapes and a generative AI neural network capable of generating shapes from text can be used to create new asset outputs. The user provided text prompt is transformed by text encoding 60 followed by vector embedding of the user input 66. In a shape remixer 62 shapes are generated from the text and used together in the neural network 32 to create a finalized output which is a remixed new 3D asset. Each shape in the shape vector database has vector embeddings attached to it. These embeddings can come from human labelled text, images of the shapes themselves, or some other vector embedding representation. When a vector embedding is used as a query in a vector database, the query is matched against all the vectors and a similarity score is given for each match in the vector database. The similarity score is a numerical representation of how similar two vector embeddings are and can be viewed as the angle between the two vectors in 2D space. The closer the similarity score is to zero degrees, the more similar the two vectors are; the closer it is to 180 degrees, the more opposite the two vectors are.

Since the similarity score represents the similarity of the vector embedding of the shape in the vector database relative to the vector embedding of the user input, a threshold can be used to ensure that what is returned is close enough, or similar enough to the user input query. If the shape vector database 68 returns a low similarity score when matching the shapes against the vector embedding of the user input text prompt then the GenAI neural network 32 is used to produce a shape. If the shape vector database 68 returns a high score then the shape which produced that score is returned instead.

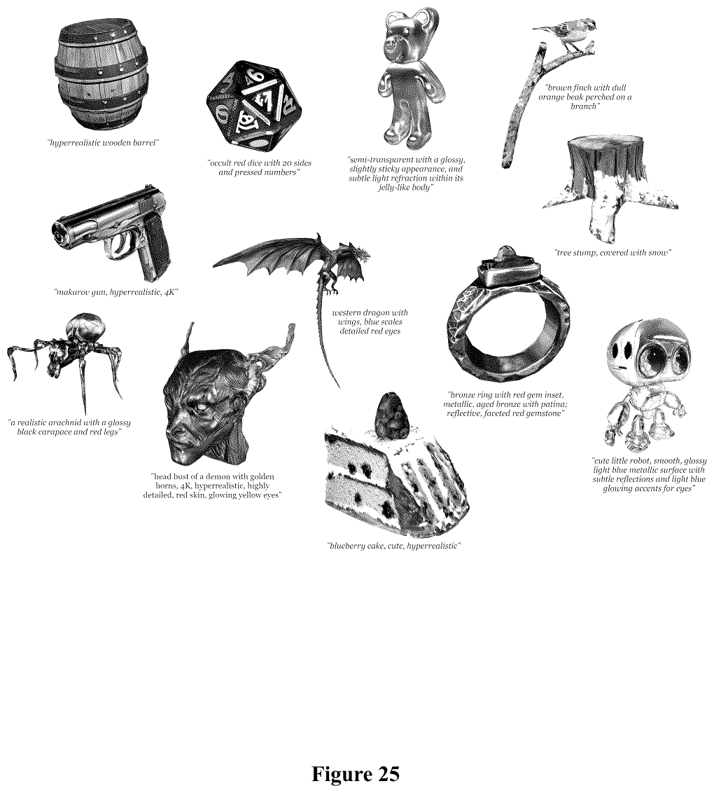

FIG. 25 is an illustration of non-humanoid outputs generated by the present 3D asset remixing system generated using different user text-based inputs with a shape vector database.

The systems and methods as presently described and variations thereof can be embodied and/or implemented at least in part as a machine configured to receive a computer-readable medium storing computer-readable instructions. The instructions are preferably executed by computer-executable components preferably integrated with the system and one or more portions of a processor and/or a controller. The computer-readable medium can be stored on any suitable computer-readable media such as RAMs, ROMs, flash memory, EEPROMs, optical devices (CD or DVD), hard drives, floppy drives, cloud storage locations, or any suitable device or devices connected by a wired or wireless network connection.

Although the present description pertains to the creation of new output 3D models using a generative AI system, it is understood that the same can be used for two dimensional (2D models), which can also composed of multiple media asset types. A similar multi-remixer approach can be used for multiple media components in a 2D image input source asset in the same way as presently described for 3D assets.

All publications, patents and patent applications mentioned in this specification are indicative of the level of skill of those skilled in the art to which this invention pertains and are herein incorporated by reference. The reference to any prior art in this specification is not, and should not be taken as, an acknowledgement or any form of suggestion that such prior art forms part of the common general knowledge.

The invention being thus described, it will be obvious that the same may be varied in many ways. Such variations are not to be regarded as a departure from the scope of the invention, and all such modifications as would be obvious to one skilled in the art are intended to be included within the scope of the following claims.

1. A computer-implemented method comprising:
receiving user input data;
receiving a source 3D asset comprising one or more media component data subsets, each media component data subset pertaining to a media component of the source 3D asset;
directing the one or more media component data subsets to a remixing pipeline selector to direct each of the plurality of media data subsets to a remixing engine specific to the media component data subset;
in a remixing engine, remixing each media component data subset in a remixer with the user input data to produce a plurality of remixed media components; and
in a merging engine, merging the plurality of remixed media components to provide a new output 3D asset.

2. The method of claim 1, wherein each of the remixers in the remixer engine comprises a generative AI.

3. The method of claim 1, wherein the source 3D asset comprises a mesh comprised of one or more vertices, polygons, and implicit surfaces.

4. The method of claim 1, wherein the media component is one or more of 3D mesh geometry, 3D point cloud geometry, 3D volumes, audio data, animation data, texture maps, texture type, material properties, asset shape, texture, animation features, structure, bones, rig, UV map, implicit surfaces, volume, skin, luminosity, skin transparency, external effects such as asset-associated graphics, voice, sound effects, sound tonality, and volume.

5. The method of claim 1, wherein the media component data subset comprises one or more of a point cloud, implicit surface, signed distance field, volume, constructive solid geometry, RGB-D image, spatial data structure, occupancy grid, 3D curve, 3D parametric surface, neural network weight that represent 3D data, neural radiance field, and mesh composed of vertices and polygons.

6. The method of claim 1, wherein the input 3D asset is provided by the user, a 3D asset repository, or a generative AI.

7. The method of claim 1, further comprising applying a new media component data subset from a template 3D model that is not one of the one or more media component data subsets in the 3D asset to add a new media component to the new output 3D asset.

8. The method of claim 1, wherein the user input data comprises one or more of text, image, video, 3D asset, audio, recorded motion, and gesture.

9. The method of claim 1, further comprising, in the merging engine, applying a weighting to the plurality of remixed media components.

10. The method of claim 1, wherein the user input data is vector embedded user input data.

11. The method of claim 1, further comprising vector embedding the user input data to provide vector embedded user input data and using the vector embedded user input data in the remixing engine.

12. The method of claim 1, further comprising calculating a similarity score between the user input data and the new output 3D asset.

13. A system for remixing 3D assets comprising:
a memory with instructions stored thereon; and
a processing device, coupled to the memory, the processing device configured to access the memory, wherein the instructions when executed by the processing device, cause the processing device to perform operations including:
receiving user input data;
receiving a source 3D asset comprising one or more media component data subsets, each media component data subset pertaining to a media component of the source 3D asset;
directing the one or more media component data subsets to a remixing pipeline selector to direct each of the plurality of media data subsets to a remixing engine specific to the media component data subset;
in a remixing engine, remixing each media component data subset in a remixer with the user input data to produce a plurality of remixed media components; and
in a merging engine, merging the plurality of remixed media components to provide a new output 3D asset.

14. The system of claim 13, wherein each remixer comprises one or more of a vector embedding function, a data pre-processing function, a generative AI (GenAI) system, a data post-processing function, and a data combination function.

15. The system of claim 13, wherein the source 3D asset is provided by the user, a 3D asset repository, or a generative AI.

16. The system of claim 13, wherein the user input data comprises one or more of text, image, video, 3D asset, audio, recorded motion, and gesture.

17. The system of claim 13, wherein the operations further comprise vector embedding the user input data to provide vector embedded user input data and using the vector embedded user input data in the remixing engine.

18. The system of claim 13, wherein the operations comprise applying a new media component data subset from a template 3D model that is not one of the one or more media component data subsets in the 3D asset to add a new media component to the new output 3D asset.

19. The system of claim 13, wherein the operations comprise, in the merging engine, applying a weighting to the plurality of remixed media components.

20. The system of claim 13, wherein the media component comprises one or more of 3D mesh geometry, 3D point cloud geometry, 3D volume, audio data, animation data, texture maps, texture type, material properties, asset shape, texture, animation features, structure, bones, rig, UV map, implicit surfaces, volume, skin, luminosity, skin transparency, external effects such as asset-associated graphics, voice, sound effects, sound tonality, and volume.
